(19) United States
(12) Patent Application Publication
(10) Pub. No.: US 2013/0061976 A1
(43) Pub. Date: Mar. 14, 2013

(54) SEMI-AUTOMATIC COIL BINDING MACHINE

(71) Applicant: Chou-Chih CHIANG, Taichung (TW)

(72) Inventor: Chou-Chih CHIANG, Taichung (TW)

(73) Assignee: Innostar Technology Pte Ltd

(21) Appl. No.: 13/231,888

(22) Filed: Sep. 13, 2011

(51) Int. Cl. B42B 5/12

(52) U.S. Cl. 140/92.3

(57) ABSTRACT

A semi-automatic coil binding machine includes a machine b as e, a coil pitch control mechanism, a cutting mechanism, a coil conveyor mechanism, a coil stop mechanism, a document conveyor mechanism and a press fit mechanism: the coil pitch control mechanism conveys a spiral coil to a predetermined length; the cutting mechanism cuts the spiral coil to a predetermined length; the coil conveyor mechanism conveys the cut spiral coil; the coil stop mechanism stops the spiral coil at a threading position from which the spiral coil is threaded onto a pile of documents; the document conveyor mechanism conveys the pile of documents with a spiral coil threaded to a press-fit position at which the spiral coil and the documents are pressed by the press fit mechanism for the spiral coil securely bonded to the documents at bookbinding and substantially increased throughput.

### BACKGROUND OF THE INVENTION

1. Field of the Invention

The present invention relates to a binding machine, especially a semi-automatic coil binding machine.

2. Description of the Prior Art

For the purpose of each leaf separately thumbed or torn off from a stack of documents, a row of holes should be punched along one side of a pile of papers for one spiral coil threaded.

A spiral coil to be introduced into holes on a pile of papers should be cut to a predetermined length which matches one document's specific length and gradually guided into holes on papers by one operator. This step completed by hands, however, spends more time in bookbinding and is relatively disadvantageous to mass production because of bulk papers to be printed for books in general.

### SUMMARY OF THE INVENTION

The object of the present invention is to save manpower and time by rendering one semi-automatic coil binding machine used to cut any spiral coil's length and perform a bookbinding operation automatically.

A semi-automatic coil binding machine to deliver the said object represents one machine base which comprises a binding platform, a coil pitch control mechanism mounted on the machine base for one spiral coil on the binding platform conveyed to a predetermined length by which the spiral coil is located on a cutting route, a cutting mechanism installed on the machine base for the spiral coil on the cutting route cut to a predetermined length, a coil conveyor mechanism accommodated on the machine base to convey the spiral coil cut by the cutting mechanism, a coil stop mechanism installed on the machine base to stop the spiral coil conveyed by the coil conveyor mechanism at a threading position from which the spiral coil is threaded onto one pile of documents, a document conveyor mechanism mounted on the machine base to convey those documents with the spiral coil threaded to a press-fit position, a press fit mechanism installed on the machine base to align and withstand the spiral coil and documents at the press-fit position for the spiral coil securely bonded to the documents.

### BRIEF DESCRIPTION OF THE DRAWINGS

The drawings disclose an illustrative embodiment of the present invention which serves to exemplify the various advantages and objects hereof, and are as follows:

FIG. 1 is the perspective view of the present invention of an assembled semi-automatic coil binding machine;

FIG. 2 is the front view of the semi-automatic coil binding machine;

FIG. 3 is the perspective view of the assembled semi-automatic coil binding machine with the shield on the top removed;

FIG. 4 is the right side view (Section A-A) of FIG. 3;

FIG. 5 and FIG. 6 illustrate one spiral coil to be cut;

FIG. 7 is the right side view of the cutting mechanism;

FIG. 8 is the perspective view of the assembled cutting mechanism;

FIG. 9 illustrates the coil conveyor mechanism and the document conveyor mechanism of the semi-automatic coil binding machine;

FIG. 10 is the perspective view of the assembled semi-automatic coil binding machine for movement of one spiral coil;

FIG. 11 is the perspective view of the assembled semi-automatic coil binding machine for movement of one spiral coil in the second embodiment;

FIGS. 12, 13 and 14 illustrate one spiral coil installed on a pile of documents;

FIG. 15 is the perspective view of the assembled semi-automatic coil binding machine for movement of documents;

FIGS. 16, 17 and 18 illustrate a press-fit action of one spiral coil;

FIG. 19 is the right side view of the press fit mechanism;

FIG. 20 is the isometric perspective view of the press fit mechanism (right);

FIG. 21 is the isometric perspective view of the press fit mechanism (left rear);

FIG. 22 is the perspective view of the assembled semi-automatic coil binding machine for an extra supporting device;

FIGS. 23 and 24 illustrate one spiral coil installed on a pile of papers (e.g., calendar).

FIGS. 25 and 26 illustrate the embodiment with a pile of papers (e.g., calendar) lifted by the supporting device to match the press fit mechanism.

### DETAILED DESCRIPTION OF THE PREFERRED EMBODIMENT

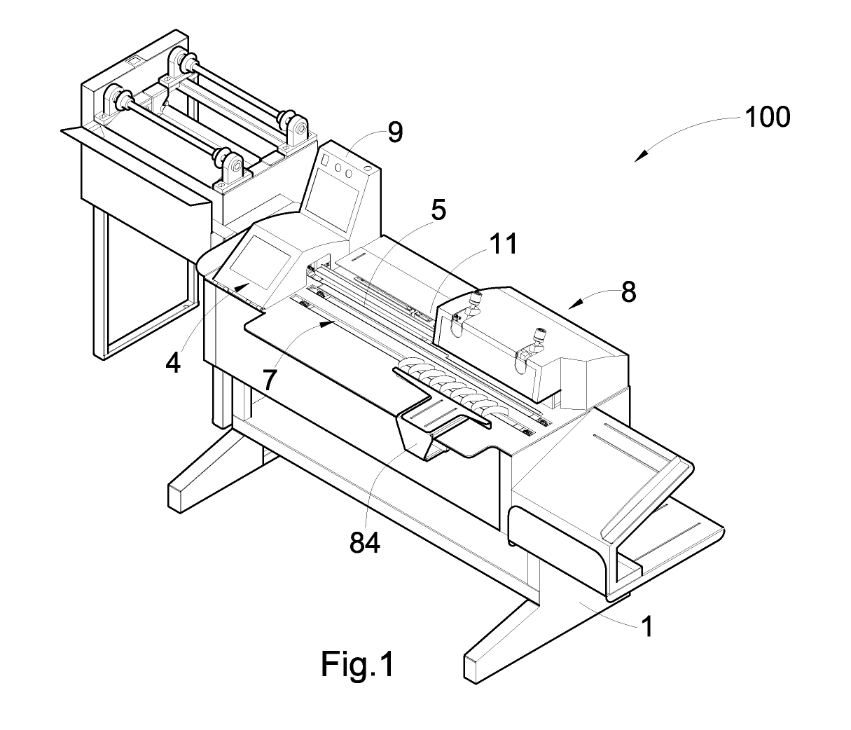

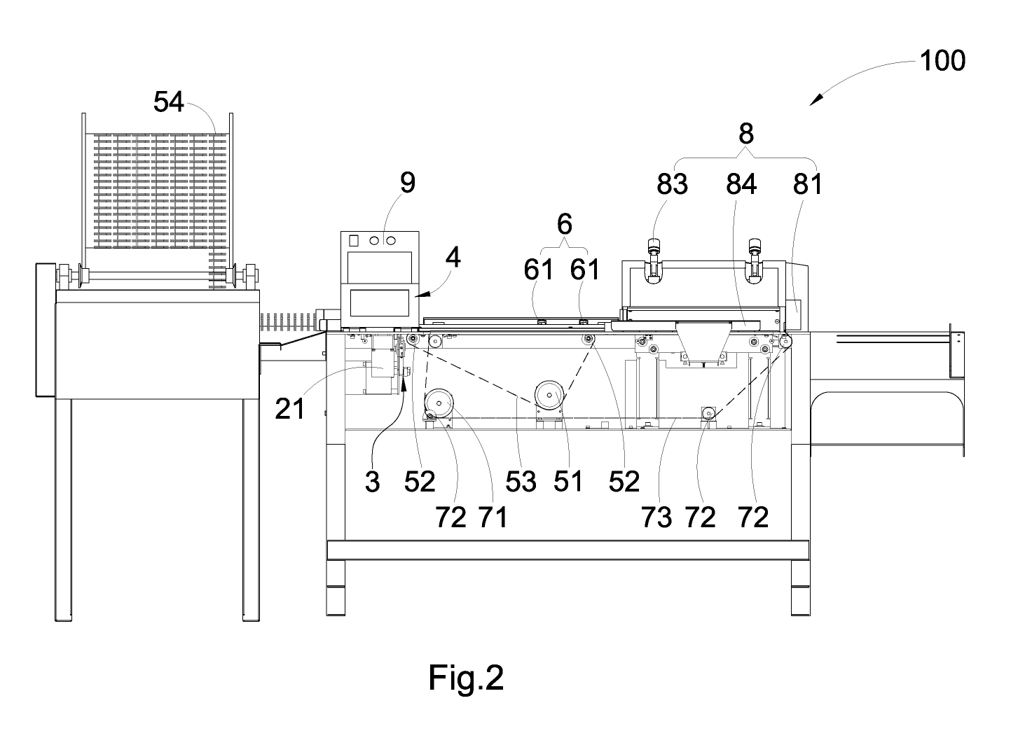

Referring to FIGS. 1 and 2 which illustrate the present invention renders a semi-automatic coil binding machine 10 which comprises a machine base 1, a coil pitch control mechanism 2, a cutting mechanism 3, a shield 4, a coil conveyor mechanism 5, a coil stop mechanism 6, a document conveyor mechanism 7, a press fit mechanism 8 and a control unit 9.

The machine base 1 is securely placed on one flat surface (e.g., ground) and equipped with a binding platform 11.

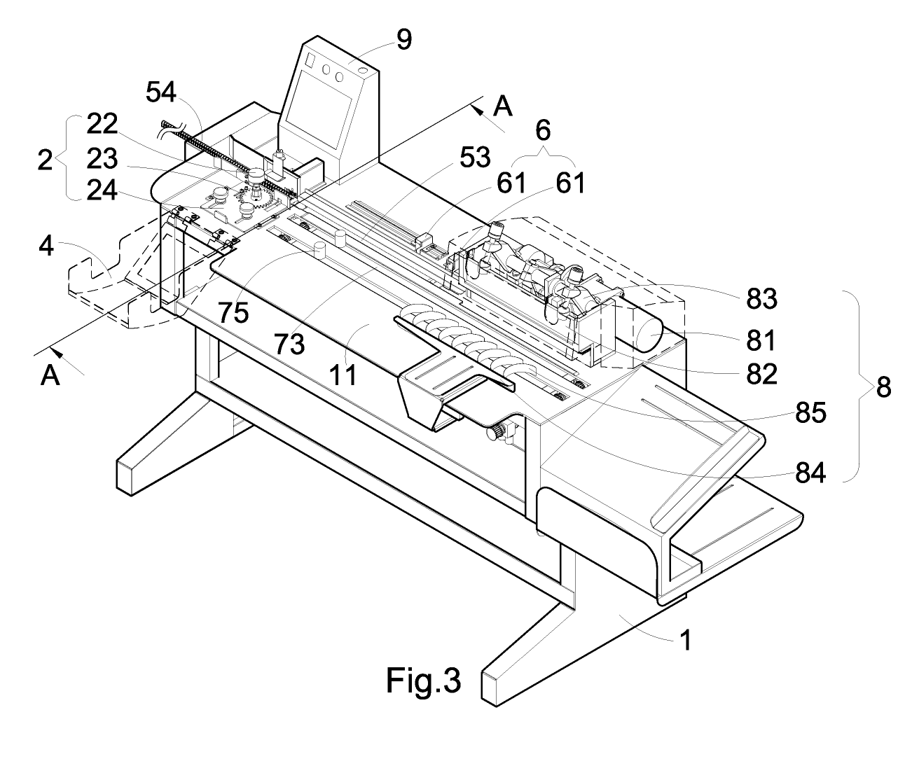

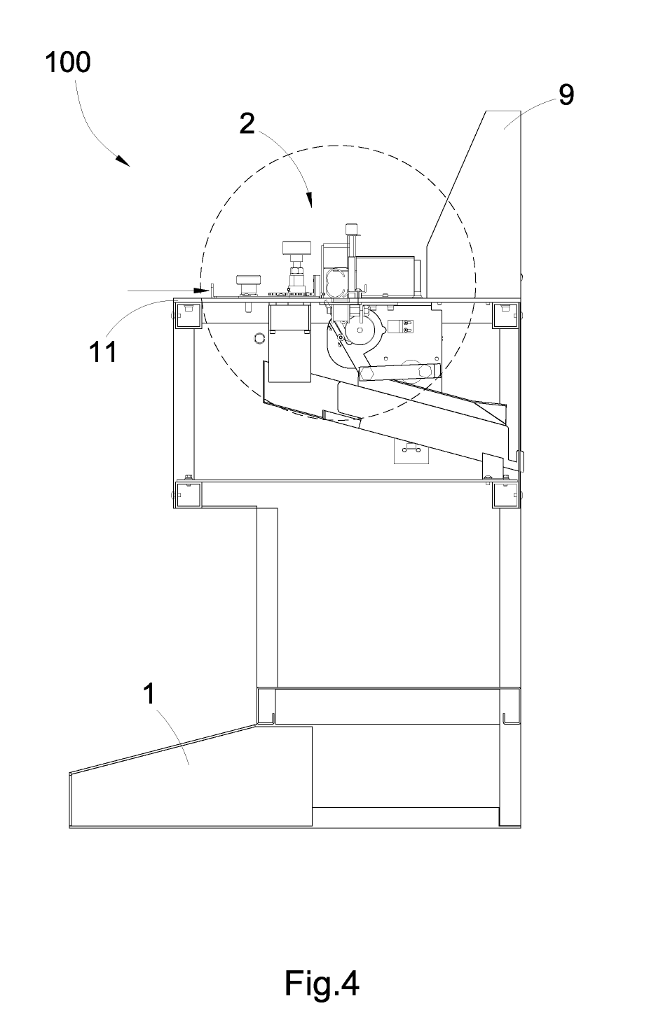

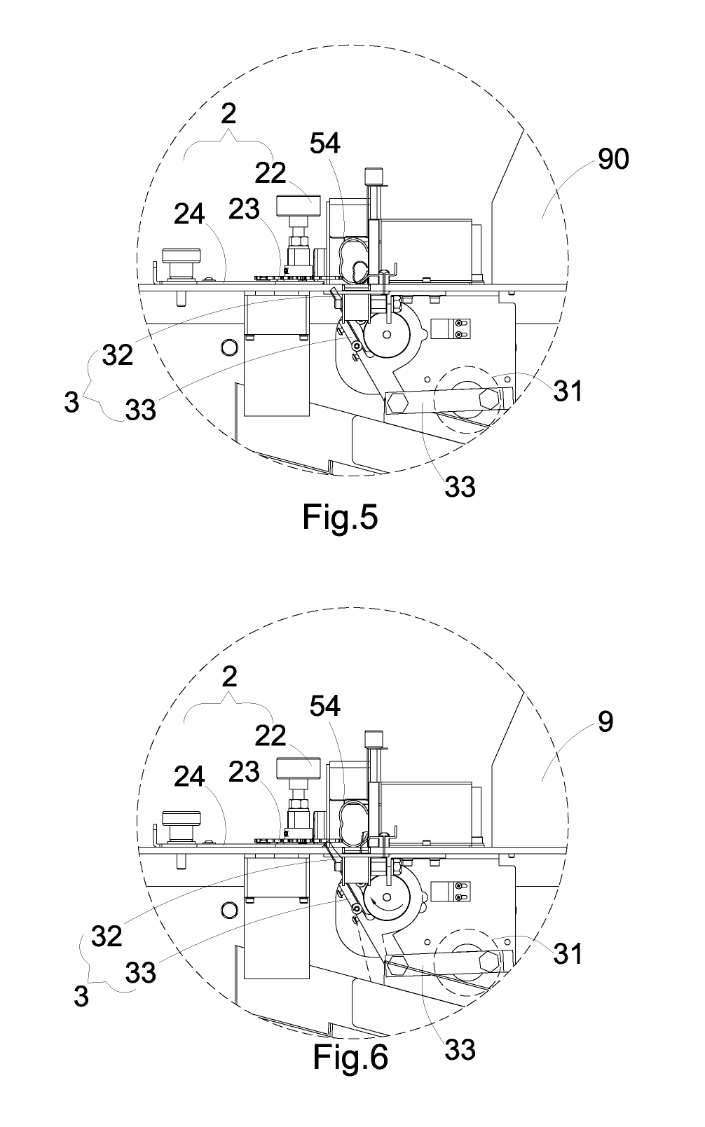

Referring to FIGS. 3, 4, 5 and 6 which illustrate the coil pitch control mechanism 2 comprises a pitch control motor 21, an assembly/disassembly device 22, a pitch control gear 23 and a regulator device 24. The pitch control motor 21 is mounted on the regulator device 24 for generation of a turning power; the assembly/disassembly device 22 is connected to the pitch control motor 21 by means of one disassembly mechanism; the pitch control gear 23 is installed on the assembly/disassembly device 22 and the binding platform 11 of the machine base 1 for the pitch control gear 23 driven by the pitch control motor 21 to predetermined turns; the regulator device 24 is mounted on the machine base 1 for a reciprocal movement between a release position and a drive position under application of one external force. That is, (1) the regulator device 24 at a release position: the pitch control gear 23 separated from a spiral coil 54 can be changed to an alternate one for another pitch with the assembly/disassembly device 22 removed from the pitch control motor 21; (2) the regulator device 24 at a drive position: the pitch control gear 23 is against the spiral coil 54 for the spiral coil 54 with a predetermined length guided into a cutting route.

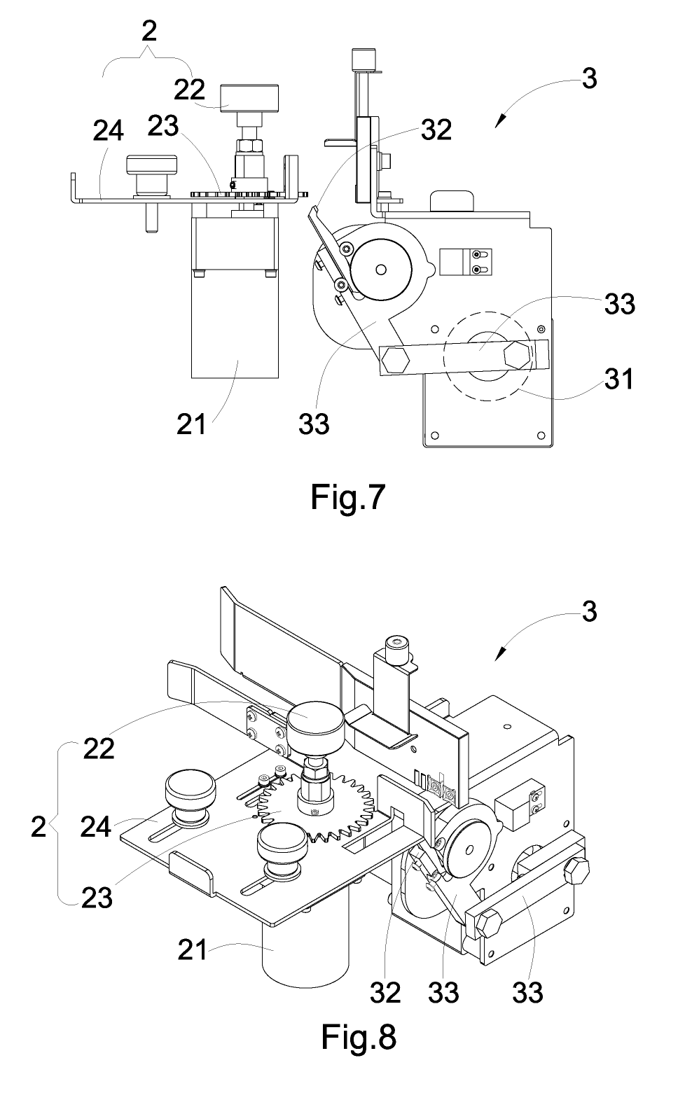

Referring to FIGS. 7 and 8 which illustrate the cutting mechanism 3 comprises a cutting motor 31, a cutter 32 and a linkage device 33. The cutting motor 31 is installed on the machine base 1 for generation of a turning power; the cutter 32 is mounted on the binding platform 11 of the machine base 1; the linkage device 33 as one lever crank mechanism is used to link the cutting motor 31 and the cutter 32 for the cutter 32 driven by the linkage device 33 and reciprocally moving between a cutting position and a retract position. Because of these mechanisms, the cutter 32 at a cutting position is able to cut the spiral coil 54 on a cutting route; the cutter 32 at a retract position is retracted from the cutting route.

The shield 4 mounted over a cutting route of the binding platform 11 on the machine base 1 is used to cover both the cutter 32 of the cutting mechanism 3 and the pitch control gear 23 of the coil pitch control mechanism 2.

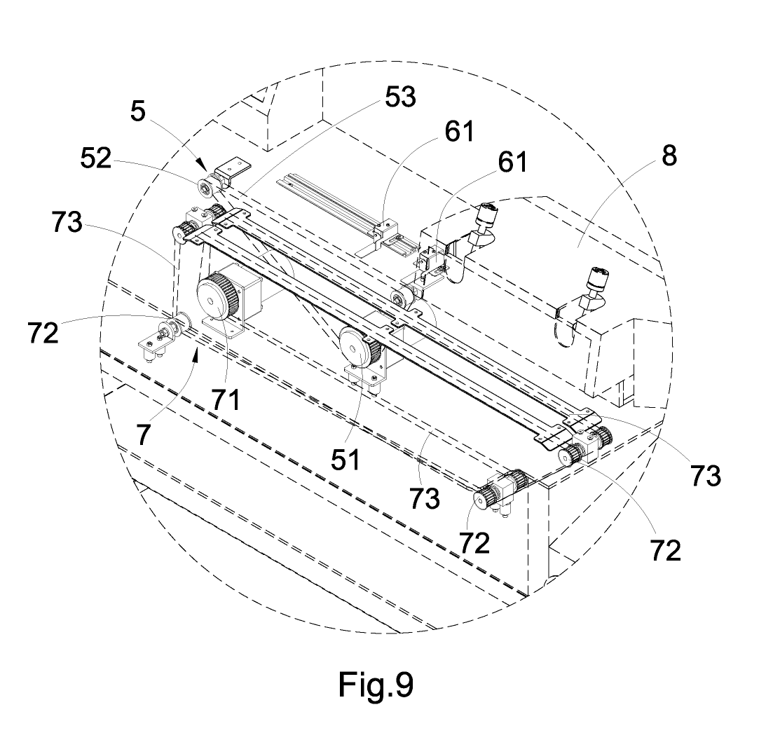

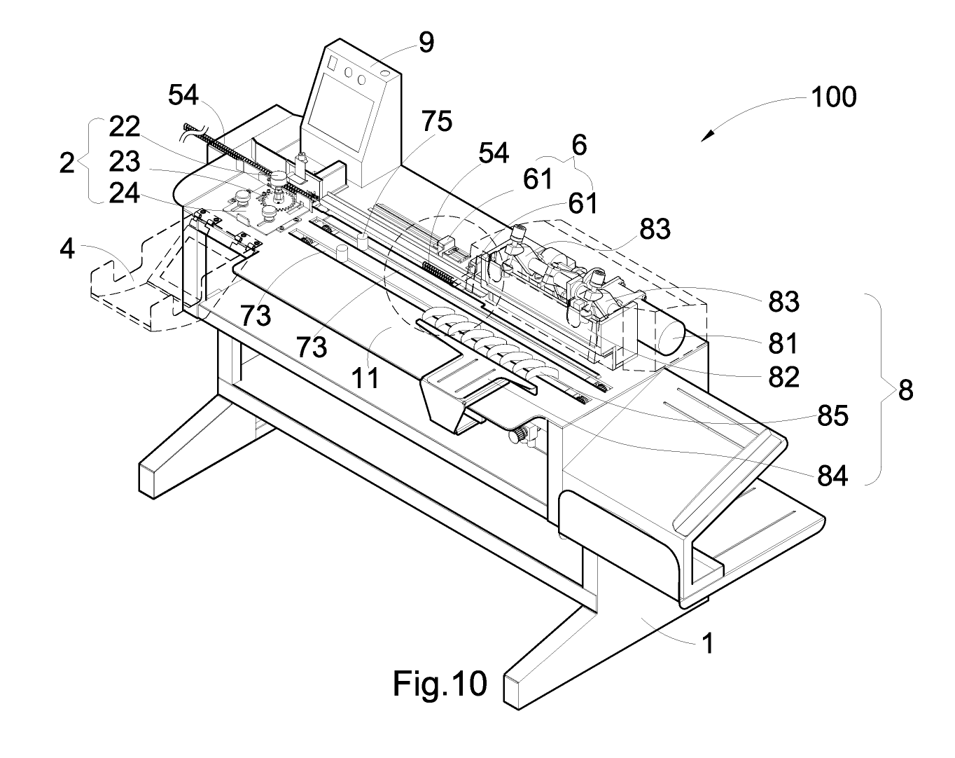

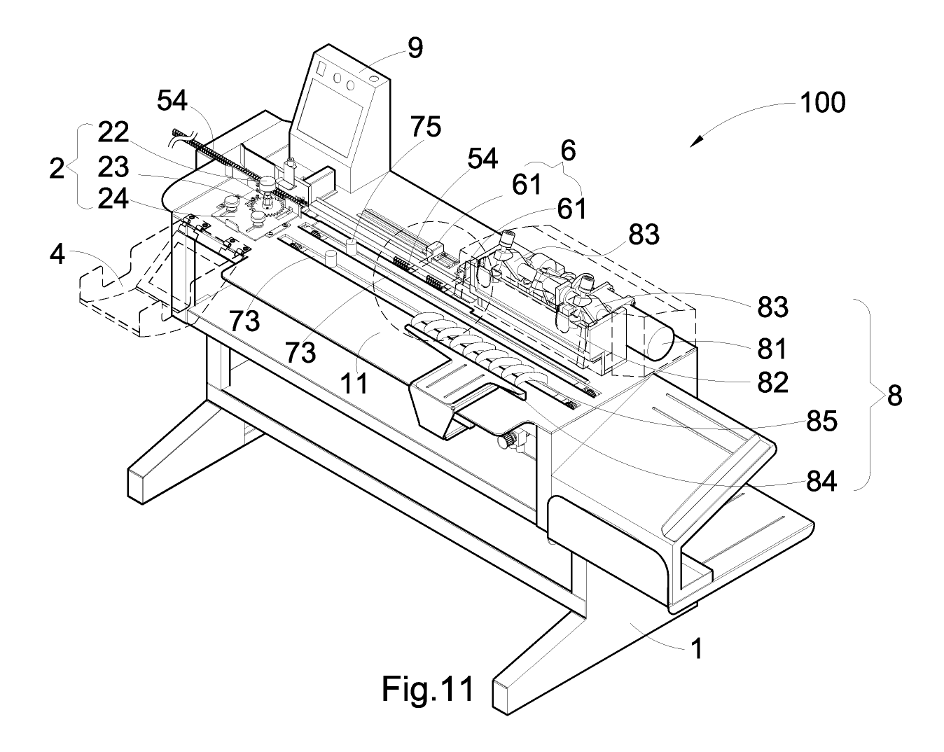

As shown in FIGS. 9, 10 and 11, the coil conveyor mechanism 5 is used in conveying the spiral coil 54 which is cut to a predetermined length by the cutting mechanism 3 to a threading position via one cutting route. The coil conveyor mechanism 5 has a coil conveyor motor 51, several coil guide pulleys 52 and a coil conveyor belt 53. The coil conveyor motor 21 is mounted on the machine base 1; the coil guide pulleys 52 are installed on the machine base 1 for spot turn wherein one coil guide pulley 52 is driven by the coil conveyor motor 51 for turning; the coil conveyor belt 53 is circled around the coil guide pulleys 52 and located at the binding platform 11 of the machine base 1 for the spiral coil 54 conveyed by the coil conveyor belt 53 to a threading position via one cutting route.

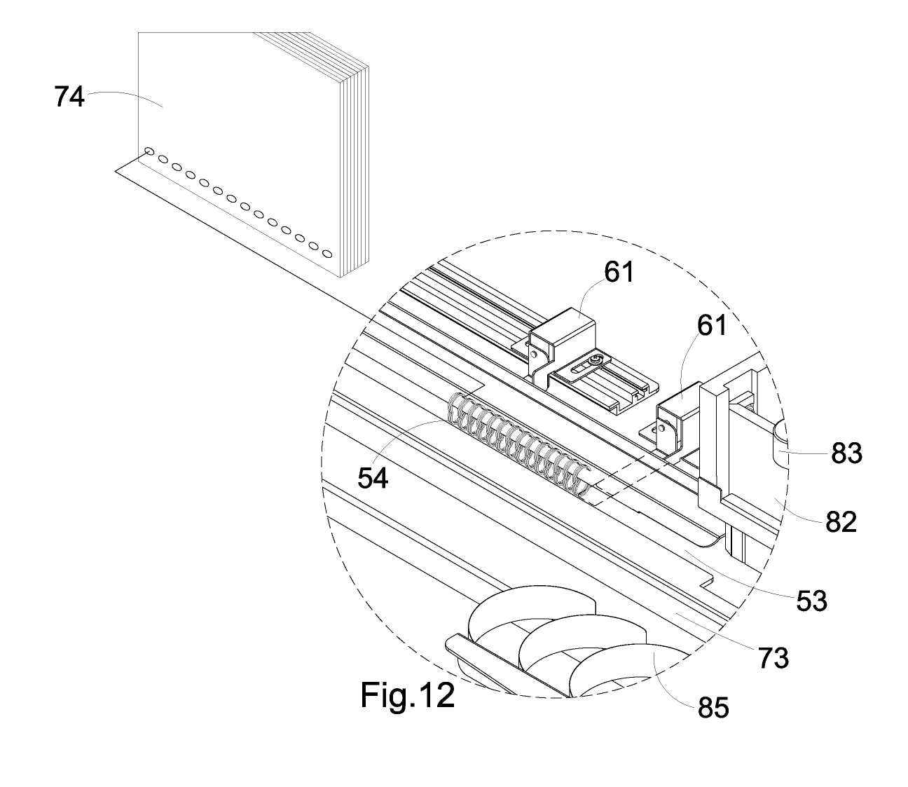

Referring to FIG. 12 which illustrates the coil stop mechanism 6 is used to stop the spiral coil 54 conveyed by the coil conveyor mechanism 5 at a threading position. The coil stop mechanism 6 comprises at least a stop unit 61 that is installed on the binding platform 11 of the machine base 1 and reciprocally moves between a stop position and a release position under control of one electric signal to stop the spiral coil 54 conveyed by the coil conveyor mechanism 5 at the threading position in which the spiral coil 54 and a pile of punched documents 74 are bonded by one operator.

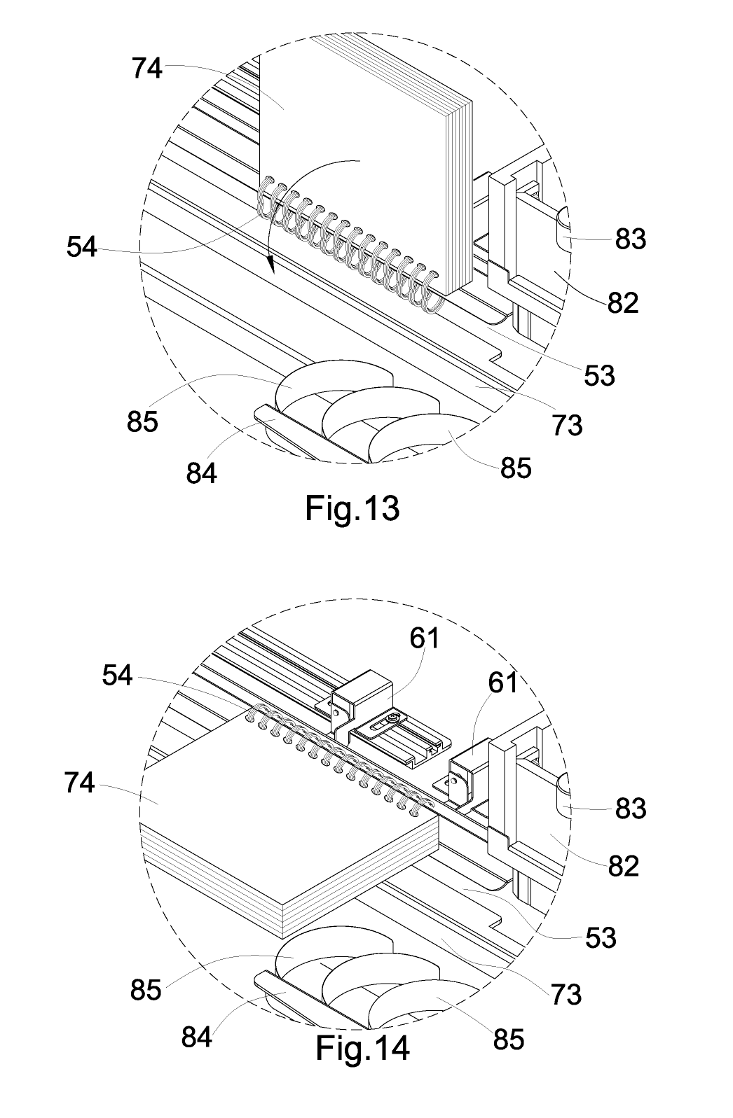

Referring to FIGS. 13 and 14 which illustrate the coil stop mechanism 6 comprises at least two stop units 61, each of which is placed on the binding platform 11 of the machine base 1 at a predetermined interval and controlled by asynchronous electric signals for asynchronous actuations of the stop units 61 and two or more spiral coils 54 stopped at the predetermined interval.

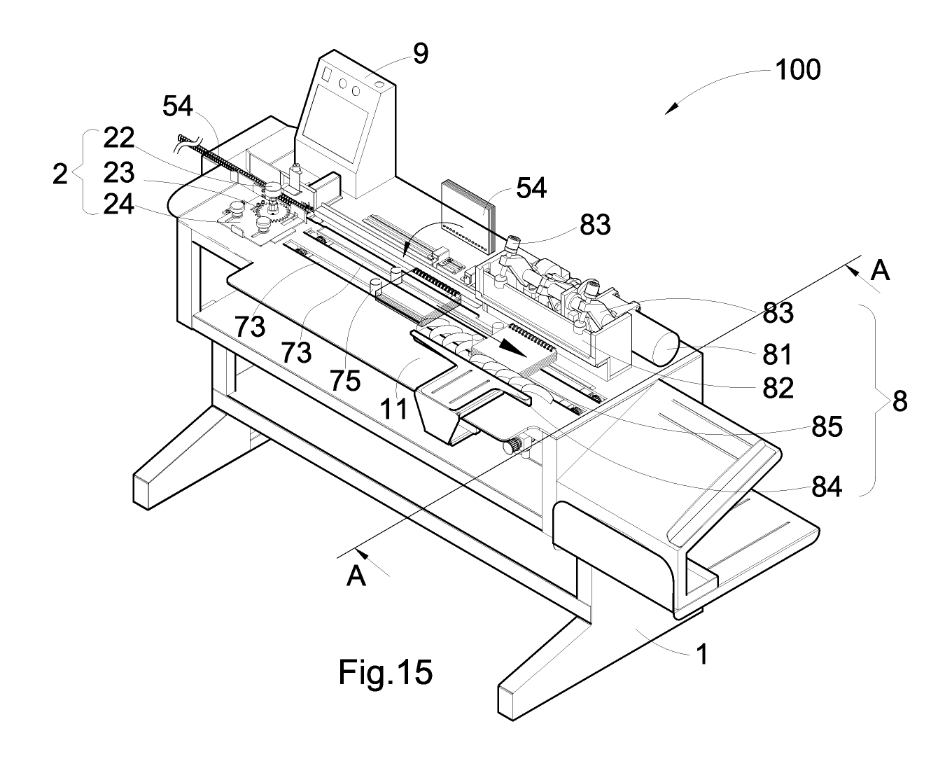

As shown in FIG. 9 and FIG. 15, the document conveyor unit 7 is used in conveying the pile of documents 74 with the spiral coil 54 threaded to a press-fit position. The document conveyor unit 7 comprises at least a document conveyor motor 71, several document guide pulleys 72 and at least a document conveyor belt 73. The document conveyor motor 71 is installed on the machine base 1; the document guide pulleys 72 are also mounted on the machine base 1 for spot turn wherein one document guide pulley 72 is driven by the document conveyor motor 71 for turning; the document conveyor belt 73 are circled around the document guide pulleys 72 and located on the binding platform 11 of the machine base 1 in order to convey the pile of documents 74 with the spiral coil 54 threaded to a press-fit position. Additionally, the document conveyor belt 73 is equipped with at least one raised conveyor part 75 by which the document 74 is withstood and transported.

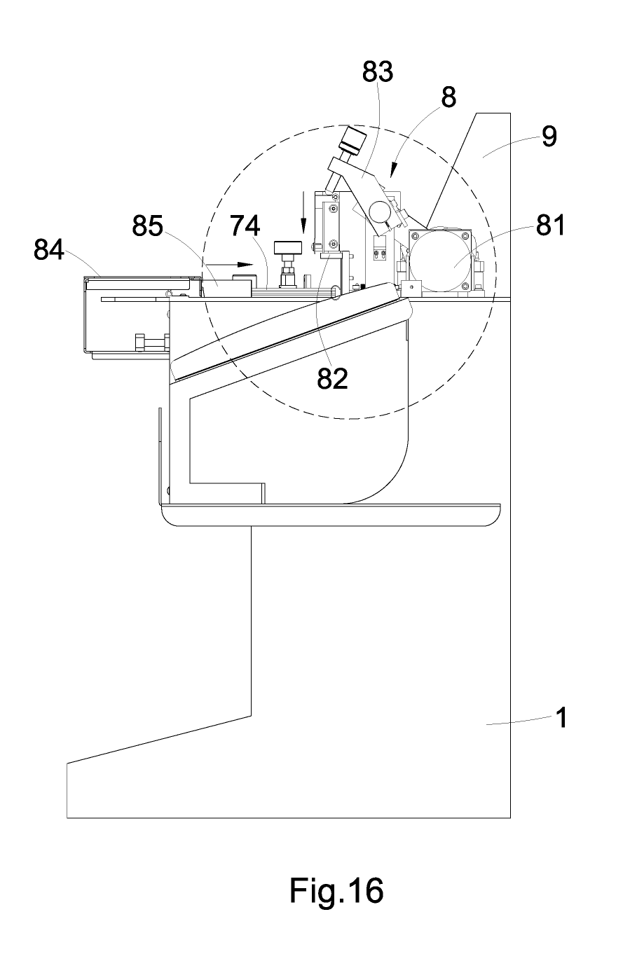

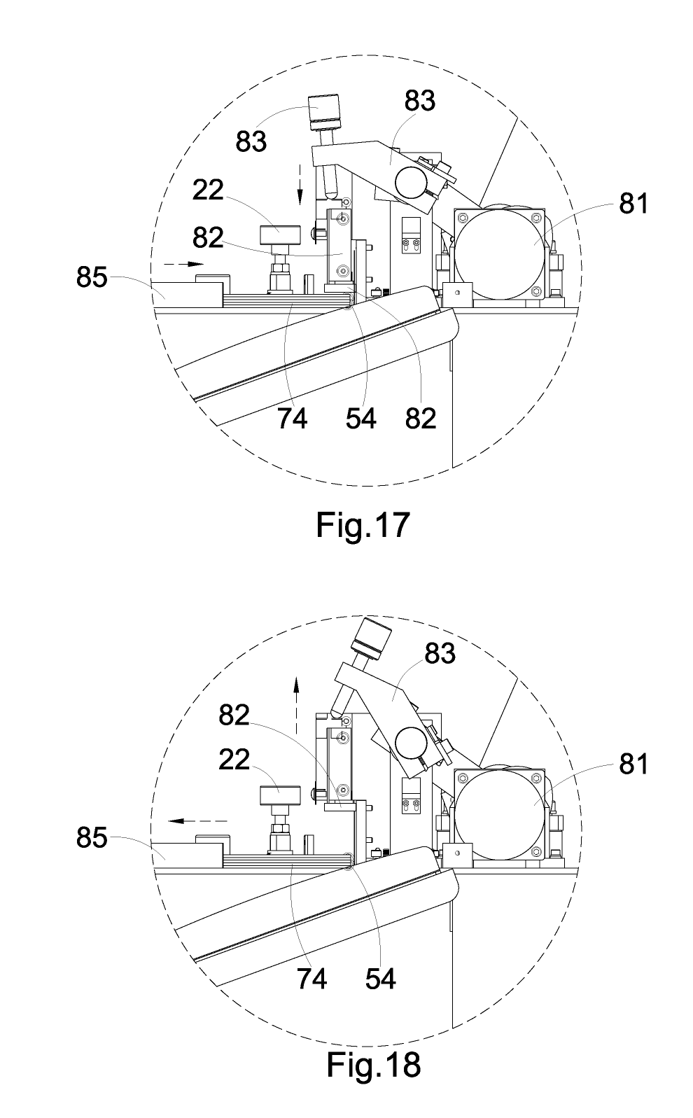

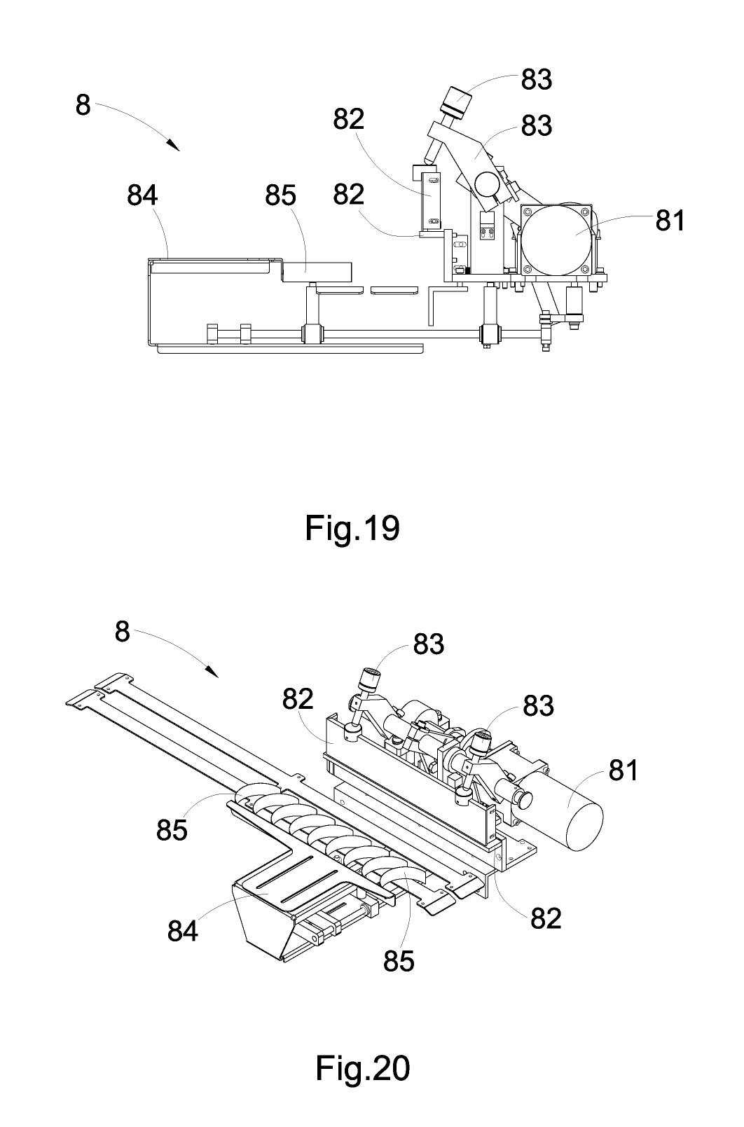

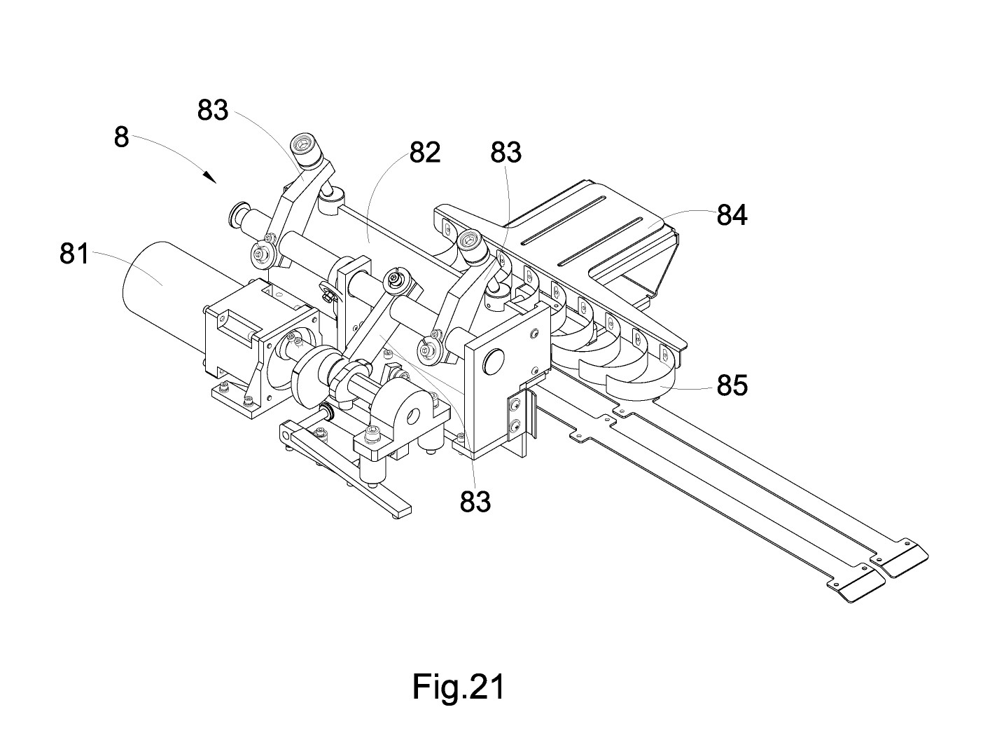

Referring to FIGS. 16˜21 which illustrate the press fit mechanism 8 installed on the machine base 1 is used to press both the spiral coil 54 and the pile of documents 74 at a press-fit position for the spiral coil 54 securely bonded to the pile of documents 74. The press fit mechanism 8 comprises a press-fit motor 81, a press-fit plate 82, a press-fit linkage device 83, a lateral-thrust linkage device 84 and several resilient bracing pads 85. The press-fit motor 81 is mounted on the machine base 1 for generation of a turning power; the press-fit plate 82 is installed on the machine base 1 and located above a press-fit position; the press-fit linkage device 83 is connected between the press-fit motor 81 and the press-fit plate 82 for the press-fit linkage device 83 actuated and driven by the press-fit motor 81 and the press-fit plate 82 reciprocally moved from high to low. That is, (1) the press-fit plate 82 at a low position: the press-fit plate 82 is against both the spiral coil 54 and the pile of documents 74 at a press-fit position for the spiral coil 54 securely bonded to the pile of documents 74; (2) the press-fit plate 82 at a high position: both the spiral coil 54 and the pile of documents 74 withstood by the press-fit plate 82 can be transported to a predetermined position through the document conveyor mechanism 7 for succeeding packing or loading. In addition, the lateral-thrust linkage device 84 is installed on the machine base 1 and connected to the press-fit linkage device 83; the resilient bracing pads 85 are mounted on the binding platform 11 of the machine base 1. The resilient bracing pads 85 driven by the lateral-thrust linkage device 84 can withstand one side of the pile of documents 74 and prevent the spiral coil 54 from deviation or collapse; the press-fit linkage device 83 activated and driven by the press-fit motor 81 can result in the press-fit plate 82 moved from high to low for press fit of a spiral coil.

The control unit 9 installed on the machine base 1 is manipulated by one user to control actuation or parameter setup of the coil pitch control mechanism 2, the cutting mechanism 3, the coil conveyor mechanism 5, the coil stop mechanism 6, the document conveyor mechanism 7 and the press fit mechanism 8.

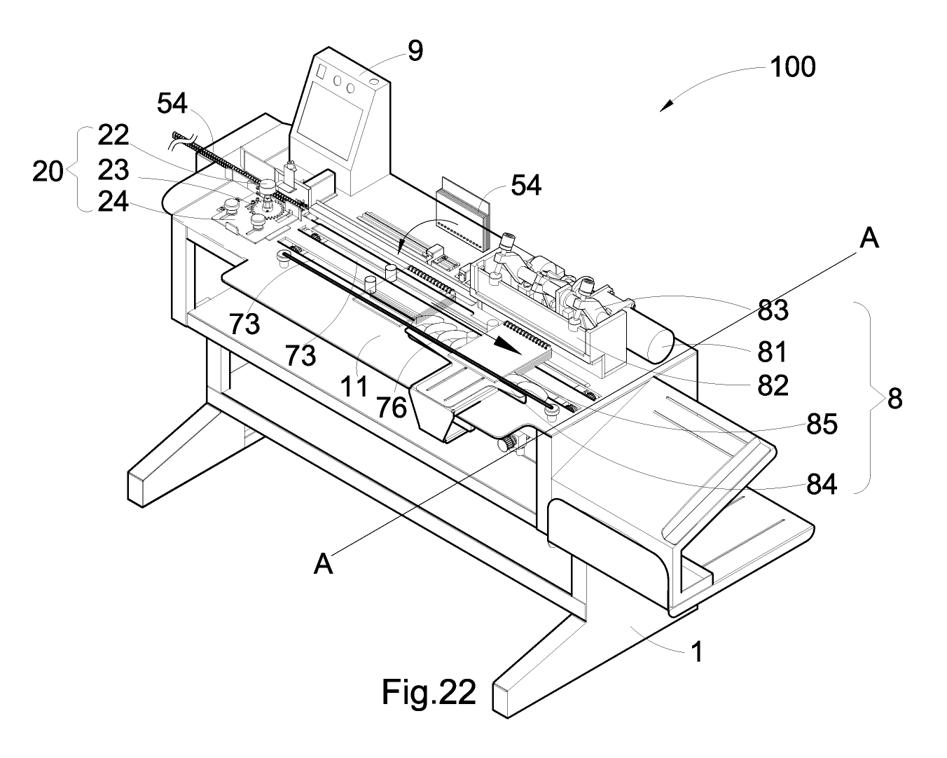

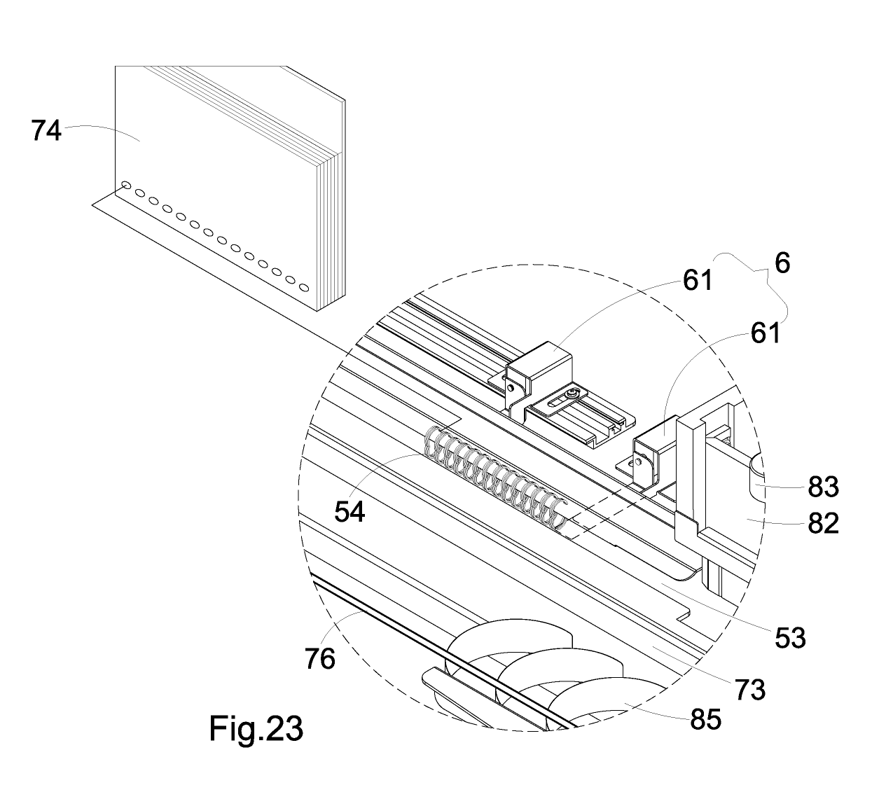

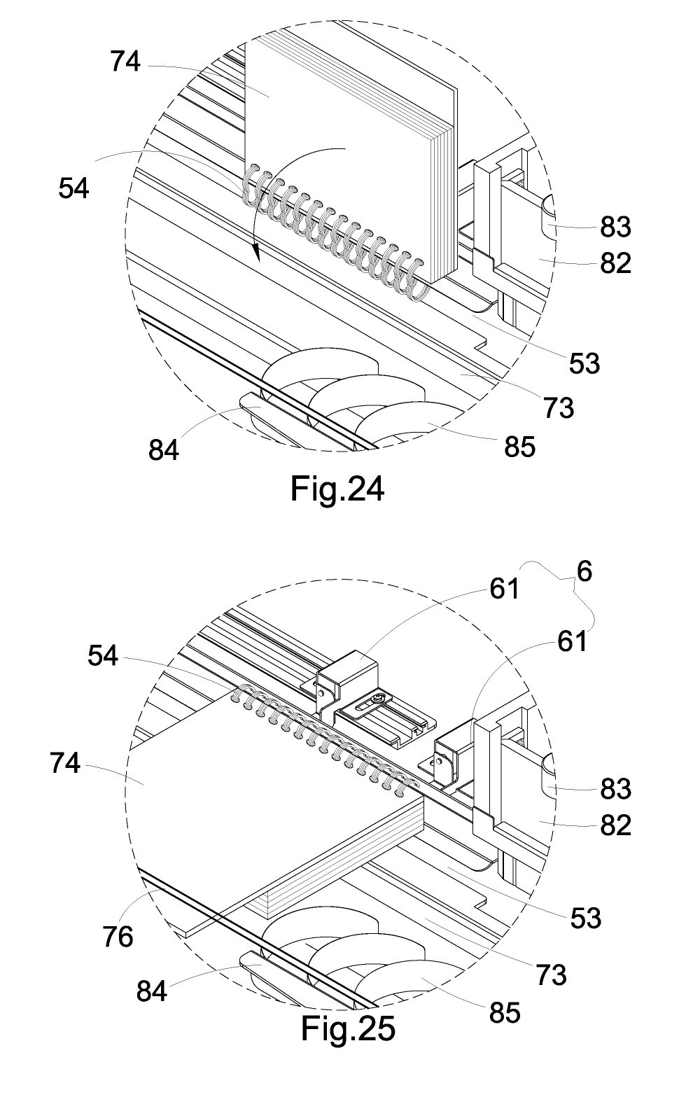

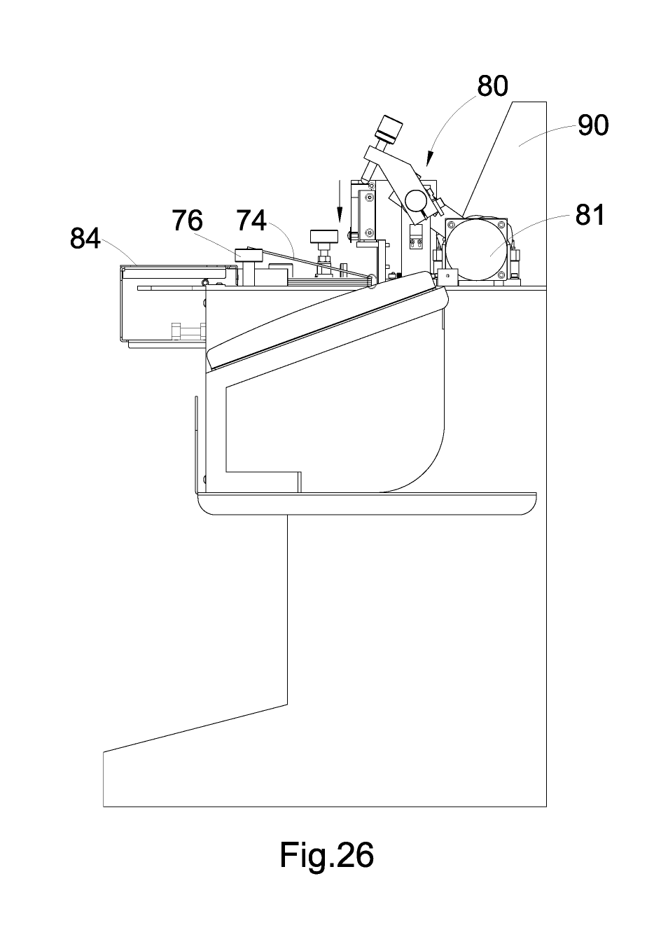

Referring to FIGS. 22˜26 which illustrate the binding platform 11 comprises a supporting device 76 used to lift one side of a pile of documents 74 for press fit of the spiral coil 54 neither an excessive length of the pile of documents 74 (e.g., cardboard on a calendar's back) that interferes with the resilient bracing pads 85 or displaces the pile of documents 74 nor the pile of documents 74 failing to be transported to a predetermined position.

Therefore, the present invention could increase throughput of both a pile of documents 74 and a spiral coil 54 and save manpower and time.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A semi-automatic coil binding machine comprising:
a machine base with a binding platform;
a coil pitch control mechanism mounted on the machine base for one spiral coil on the binding platform conveyed to a predetermined distance by which the spiral coil is located on a cutting route;
a cutting mechanism installed on the machine base for the spiral coil on the cutting route cut to a predetermined length;
a coil conveyor mechanism accommodated on the machine base to convey the spiral coil cut by the cutting mechanism;
a coil stop mechanism installed on the machine base to stop the spiral coil conveyed by the coil conveyor mechanism at a threading position from which the spiral coil is threaded onto one pile of documents;
a document conveyor mechanism mounted on the machine base to convey those documents with the spiral coil threaded to a press-fit position; and
a press fit mechanism installed on the machine base to align and withstand both the spiral coil and documents at the press-fit position for the spiral coil securely bonded to the documents.

2. The semi-automatic coil binding machine according to claim 1 wherein the coil pitch control mechanism is equipped with a pitch control motor, an assembly/disassembly device and a pitch control gear; the pitch control motor is mounted under the regulator device for generation of a turning power; the assembly/disassembly device is connected to the pitch control motor by means of one disassembly mechanism; the pitch control gear is installed on the assembly/disassembly device and located on the binding platform of the machine base for the pitch control gear driven by the pitch control motor to predetermined turns and the spiral coil conveyed to the cutting route.

3. The semi-automatic coil binding machine according to claim 2 wherein the coil pitch control mechanism is also equipped with a regulator device which is mounted on the machine base for a reciprocal movement between a release position and a drive position under application of one external force: (1) the regulator device at a release position: the pitch control gear separated from a spiral coil can be changed to an alternate one for another pitch with the assembly/disassembly device removed from the pitch control motor; (2) the regulator device at a drive position: the pitch control gear is against the spiral coil for the spiral coil with a predetermined length guided into a cutting route.

4. The semi-automatic coil binding machine according to claim 1 wherein the cutting mechanism is provided with a cutting motor, a cutter and a linkage device; the cutting motor is installed on the machine base for generation of a turning power; the cutter is mounted on the binding platform of the machine base; the linkage device is connected to both the cutting motor and the cutter for the cutter driven by the linkage device and reciprocally moving between a cutting position to cut the spiral coil on a cutting route and a retract position retracted from the cutting route.

5. The semi-automatic coil binding machine according to claim 1 wherein the coil conveyor mechanism is provided with a coil conveyor motor, several coil guide pulleys and a coil conveyor belt; the coil conveyor motor is installed on the machine base; the coil guide pulleys are mounted on the machine base for spot turn and one coil guide pulley is driven by the coil conveyor motor for turning; the coil conveyor belt is circled around the coil guide pulleys and installed on the binding platform of the machine base for the spiral coil conveyed to a threading position from a cutting route.

6. The semi-automatic coil binding machine according to claim 1 wherein the coil stop mechanism is equipped with at least a stop unit, which is installed on the binding platform and controlled by an electric signal to reciprocally move between a stop position and a release position and stop the spiral coil conveyed by the coil conveyor mechanism at a threading position from which the spiral coil and one pile of punched documents are bonded by one operator when the stop unit is located at the stop position.

7. The semi-automatic coil binding machine according to claim 1 wherein the coil stop mechanism comprises at least two stop units, each of which is mounted on the binding platform of the machine base at a predetermined interval and controlled by asynchronous electric signals for asynchronous actuations of the stop units and two or more spiral coils stopped at the predetermined interval.

8. The semi-automatic coil binding machine according to claim 1 wherein the document conveyor unit is provided with at least a document conveyor motor, several document guide pulleys and at least a document conveyor belt; the document conveyor motor is installed on the machine base; the document guide pulleys are also mounted on the machine base for spot turn and one document guide pulley is driven by the document conveyor motor for turning; the document conveyor belt is circled around the document guide pulleys and located on the binding platform in order to convey the pile of documents with the spiral coil threaded to a press-fit position.

9. The semi-automatic coil binding machine according to claim 1 wherein the press fit mechanism is equipped with a press-fit motor, a press-fit plate and a press-fit linkage device; the press-fit motor is installed on the machine base for generation of a turning power; the press-fit plate is mounted on the machine base and located above a press-fit position; the press-fit linkage device is connected between the press-fit motor and the press-fit plate for the press-fit linkage device actuated and driven by the press-fit motor and the press-fit plate reciprocally moving from high to low: (1) the press-fit plate at a low position: the press-fit plate withstands both a spiral coil and a pile of documents at a press-fit position for the spiral coil securely coupled with the documents; (2) the press-fit plate at a high position: both the spiral coil and the pile of documents withstood by the press-fit plate can be transported to a predetermined position through the document conveyor mechanism for succeeding packing or loading.

10. The semi-automatic coil binding machine according to claim 9 wherein the press fit mechanism is provided with a lateral-thrust linkage device, which is mounted on the machine base and connected to the press-fit linkage device, and several resilient bracing pads, which are installed on the binding platform; the lateral-thrust linkage device is used in driving the resilient bracing pads to be against one side of a pile of documents and prevent the spiral coil from deviation and collapse; the press-fit linkage device activated and driven by the press-fit motor can result in the press-fit plate moved from high to low for press fit of a spiral coil.
